(19) United States
(12) Patent Application Publication
(10) Pub. No.: US 2009/0003750 A1
(43) Pub. Date: Jan. 1, 2009

(54) ROLLER BEARING

(76) Inventor: No CHEN, Taichung (TW)

Correspondence Address: NIXON & VANDERHYE, PC, 901 NORTH GLEBE ROAD, 11TH FLOOR, ARLINGTON, VA, 22203, US

(21) Appl. No.: 12/145,907

(22) Filed: Jun. 25, 2008

(30) Foreign Application Priority Data
Jun. 27, 2007 (TW) 096210465

(51) Int. Cl. F16C 33/46

(52) U.S. Cl. 384/572

(57) ABSTRACT

A roller bearing includes: an outer race; a cage surrounded by the outer race and including two cage rings and a plurality of pillars interconnecting the cage rings and displaced angularly from each other to define a plurality of roller-receiving spaces thereamong, each of the cage rings being formed with a plurality of retaining holes, each of which is in spatial communication with a respective one of the roller-receiving spaces; a plurality of primary rollers received in the roller-receiving spaces, respectively; and a plurality of urging members, each of which is received in a respective one of the roller-receiving spaces and each of which extends into a respective axially aligned pair of the retaining holes in the cage rings.

### CROSS-REFERENCE TO RELATED APPLICATION

This application claims priority of Taiwanese Application No. 096210465, filed on Jun. 27, 2007.

### BACKGROUND OF THE INVENTION

1. Field of the Invention

This invention relates to a roller bearing, more particularly to a roller bearing including a cage having two cage rings formed with retaining holes for holding end sections of urging members.

2. Description of the Related Art

FIG. 1 illustrates a conventional unidirectional roller bearing that includes an outer race 71 formed with a plurality of inclined roller-driving surfaces 710, a cage 72 received in the outer race 71 and farmed with a plurality of angularly displaced retaining spaces 721, a plurality of cylindrical rollers 74 received in the retaining spaces 721 and driven by the inclined roller-driving surfaces 710, a plurality of urging members 73 received in the retaining spaces 721 for urging the cylindrical rollers 74, and inner race (not shown) received in the cage 72. The inclined roller-driving surfaces 710 of the outer race 71 permit the inner race to be driven to co-rotate with the outer race 71 when the outer race 71 rotates in a first rotational direction, and to be not driven to cc-rotate with the outer race 71 when the outer race 71 rotates in a second rotational direction opposite to the first rotational direction. During assembly of the unidirectional roller bearing, the urging members 73 are first pressed into the retaining spaces 721, and the rollers 74 are subsequently pressed into the retaining spaces 721. Since the urging members 73 are retained in the retaining spaces 721 in a press-fit engaging manner, they are likely to jump undesirably out of the retaining spaces 721 due to pressing action of the rollers 74 into the retaining spaces 721.

### SUMMARY OF THE INVENTION

Therefore, an object of the present invention is to provide a roller bearing that can overcome the aforesaid drawback associated with the prior art.

According to this invention, there is provided a roller bearing that comprises an outer race; a cage surrounded by the outer race and including two cage rings that are coaxially disposed and that are axially spaced apart from each other, and a plurality of pillars interconnecting the cage rings and displaced angularly from each other to define a plurality of roller-receiving spaces thereamong, each of the cage rings being formed with a plurality of retaining holes, each of which is in spatial communication with a respective one of the roller-receiving spaces, each of the retaining holes in one of the cage rings being axially aligned with a respective one of the retaining holes in the other of the cage rings; a plurality of primary rollers received in the roller-receiving spaces, respectively; and a plurality of urging members, each of which is received in a respective one of the roller-receiving spaces for urging a respective one of the primary rollers, and each of which extends into a respective axially aligned pair of the retaining holes in the cage rings so as to be retained between the cage rings.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is an exploded perspective view of a conventional unidirectional roller bearing;

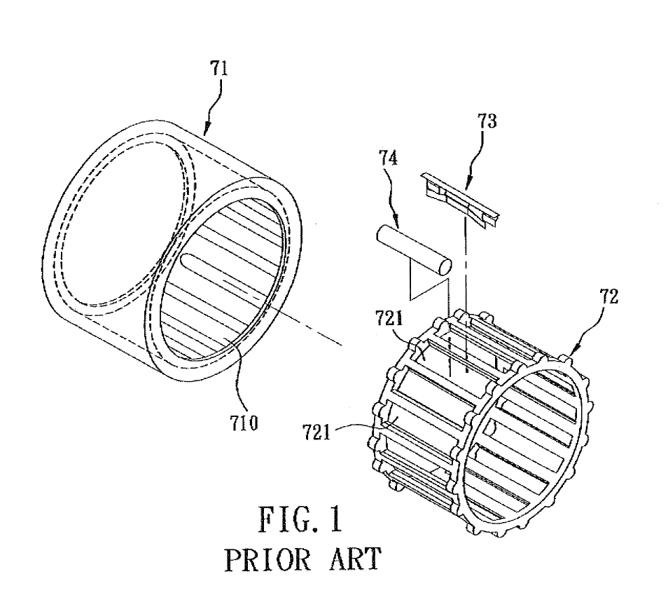

FIG. 2 is an exploded perspective view of the preferred embodiment of a roller bearing according to this invention;

FIG. 3 is a sectional view of a cage of the preferred embodiment;

FIG. 4 is a sectional view taken along line IV-IV in FIG. 3;

FIG. 5 is a perspective view of an urging member of the preferred embodiment;

FIG. 6 is a radial sectional view of the preferred embodiment; and

FIG. 7 is an axial sectional view of the preferred embodiment.

### DETAILED DESCRIPTION OF THE PREFERRED EMBODIMENT

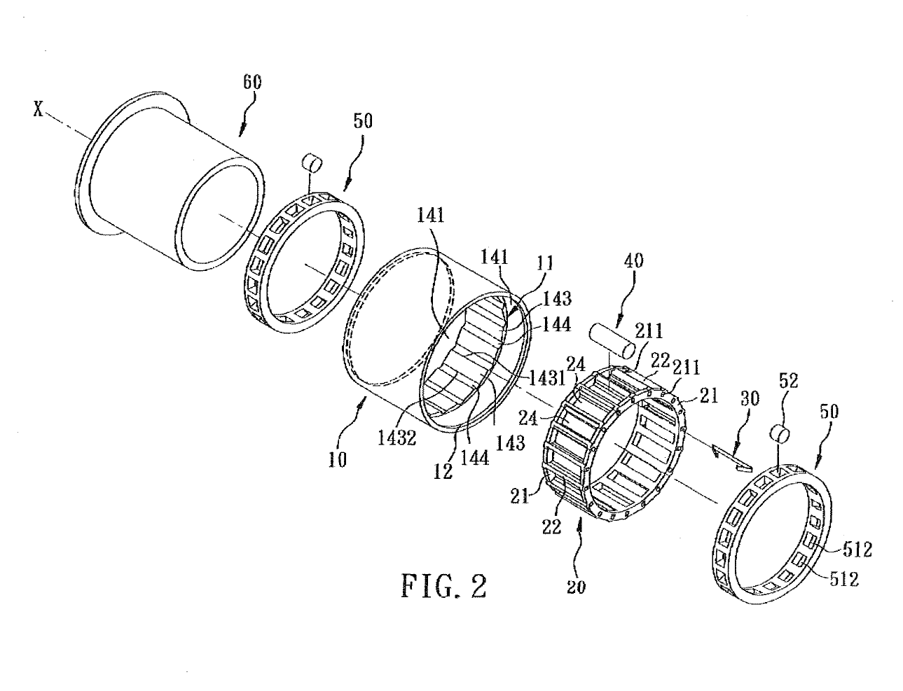

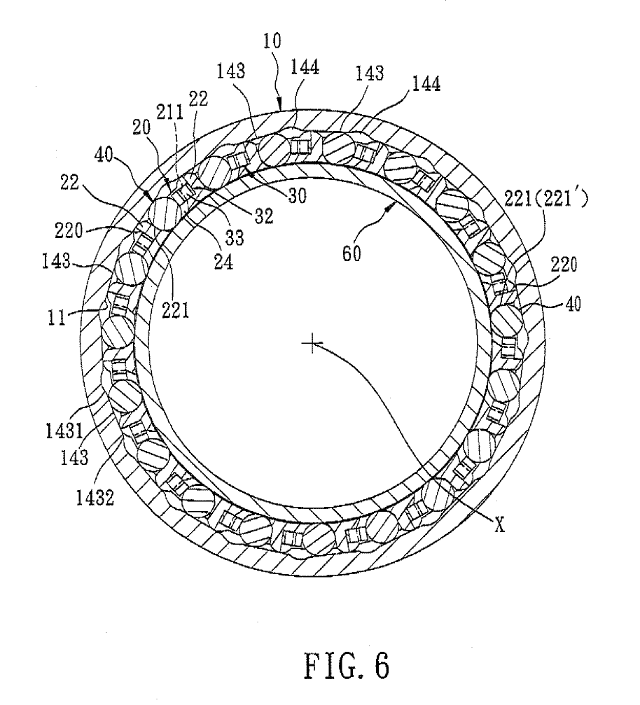

FIGS. 2 and 6 illustrate the preferred embodiment of a roller bearing according to this invention. The roller bearing includes: an outer race 10; a cage 20 surrounded by the outer race 10 and including two cage rings 21 that are coaxially disposed and that are axially spaced apart from each other, and a plurality of pillars 22 interconnecting the cage rings 21 and displaced angularly from each other to define a plurality of roller-receiving spaces 24 thereamong, each of the cage rings 21 being formed with a plurality of retaining holes 211, each of which is in spatial communication with a respective one of the roller-receiving spaces 24, each of the retaining holes 211 in one of the cage rings 21 being axially aligned with a respective one of the retaining holes 211 in the other of the cage rings 21; a plurality of primary rollers 40 received in the roller-receiving spaces 24, respectively, and a plurality of urging members 30, each of which is received in a respective one of the roller-receiving spaces 24 for urging a respective one of the primary rollers 40, and each of which extends into a respective axially aligned pair of the retaining holes 211 in the cage rings 21 so as to be retained between the cage rings 21.

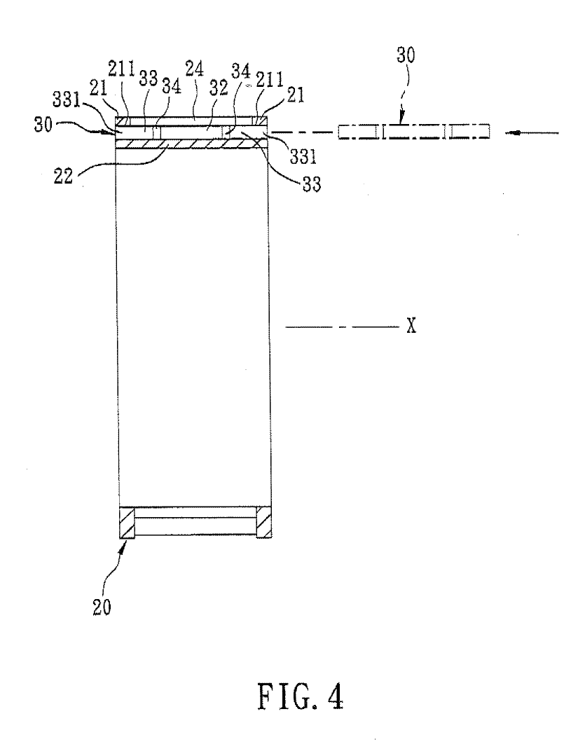

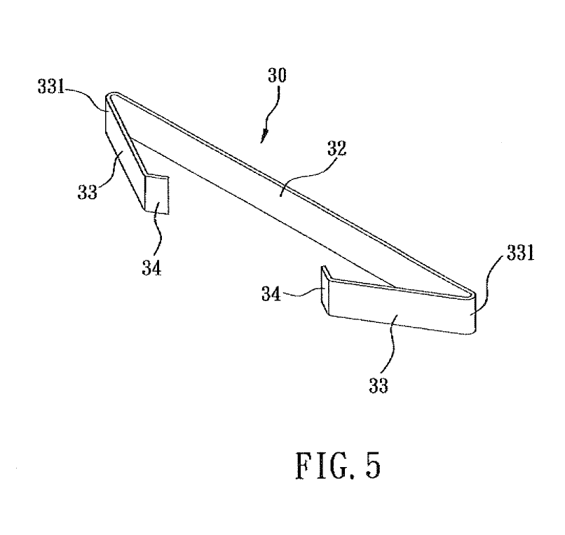

In this embodiment, each of the urging members 30 is in the form of a bent plate (see FIGS. 4, 5 and 7) that has two opposite end sections 33 and a middle section 32 extending between the end sections 33. The end sections 33 are bent from the middle section 32 toward each other to define two folded ends 331 thereamong and to Form two resilient arms for abutting resiliently against the respective one of the primary rollers 40. The folded ends 331 formed on the bent plate of each of the urging members 30 are received in the respective axially aligned pair of the retaining holes 211 in the cage rings 21, respectively. Each of the end sections 33 of the bent plate of each of the urging members 30 has a bent free end 34 that is bent therefrom toward the middle section 32 of the bent plate of the respective one of the urging members 30.

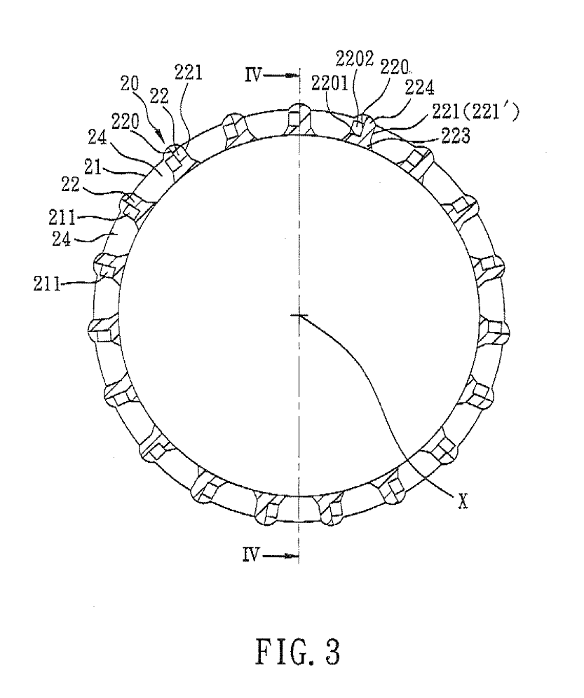

Referring to FIG. 3, in combination with FIG. 6, each of the pillars 22 has a spring-abutting side 220 having a generally L-shaped surface that defines a shoulder 2201 and a recess 2202. Each of the urging members 30 is received in the recess 2202 in a respective one of the pillars 22, and is seated on the shoulder 2201 defined by the L-shaped surface of the spring-abutting side 220 of the respective one of the pillars 22. Each of the pillars 22 further has a roller-abutting side 221 opposite to the spring-abutting side 220, and includes an inner segment 223 and an outer segment 224 reduced in width between the roller-abutting side 221 and the spring-abutting side 220 from the inner segment 223 toward the outer race 10 to define the L-shaped surface at the spring-abutting side 220 and a bent surface 221′ at the roller-abutting side 221 for guiding movement of a respective one of the primary rollers 40 therealong. The middle section 32 of the bent plate of each of the urging members 30 abuts against the spring-abutting side 220 of the respective one of the pillars 22.

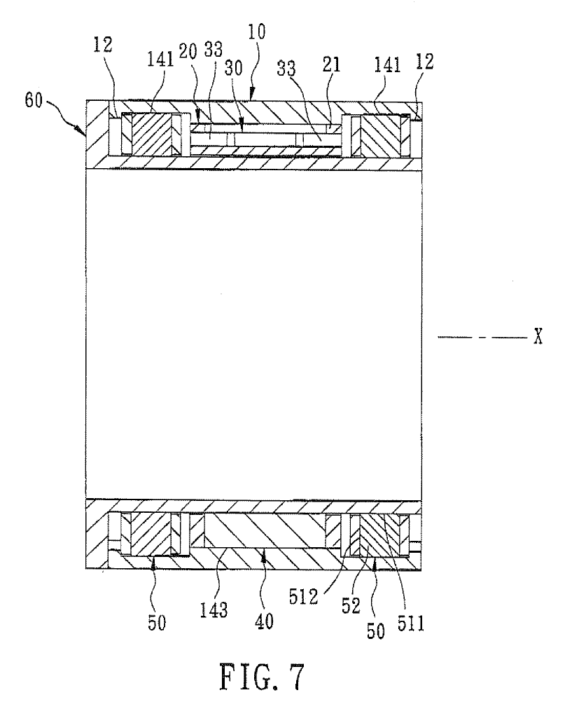

The outer race 10 has an annular inner protrusion 11 that protrudes inwardly therefrom and that is formed with a plurality of axially extending grooves 144 which are angularly displaced so as to define a plurality of roller-driving surfaces 143 thereamong for abutting against the primary rollers 40 (See FIGS. 2 and 6), respectively. Each of the roller-driving surfaces 143 has opposite axially extending first and second sides 1431, 1432 (see FIG. 2) that differ from each other in terms of radial distance from an axis (X) of the outer race 10. The outer race 10 further has two opposite end flanges 12 that protrude inwardly and radially therefrom and that are respectively disposed at two opposite sides of the inner protrusion 11 to define two retaining spaces 141 thereamong. Two auxiliary rings 50 are received in the retaining spaces 141, respectively. Each of the auxiliary rings 50 is formed with a plurality of roller-retaining holes 512. A plurality of auxiliary rollers 52 are retained in the roller-retaining holes 512 in the auxiliary rings 50, respectively, and are in rotational contact with the outer race 10 (see FIGS. 2 and 7).

An inner race 60 extends into and through the outer race 10, the cage 20, and the auxiliary rings 50, and is in contact with the primary rollers 40 and the auxiliary rollers 52.

In this embodiment, the roller bearing is an unidirectional type roller bearing. In use, when the outer race 10 is driven by a driving unit (not shown) to rotate about the axis (X) thereof in a first rotational direction (not shown), the primary rollers 40 will be pushed by the roller-driving surfaces 143 to move against urging action of the urging members 30 until they are pressed tightly against the inner race 60 by the roller-driving surfaces 143 to permit the inner race 60 to be driven to co-rotate with the outer race 10. On the contrary, when the outer race 10 is driven to rotate in a second rotational direction opposite to the first rotational direction, the primary rollers 40 are urged by the urging members 30 to move along the roller-abutting sides 221 of the pillars 22, respectively, and are not pressed by the roller-driving surfaces 143 against the inner race 60, thereby permitting the inner race 60 to remain idle while the outer race 10 rotates in the second rotational direction.

During assembly, each of the urging members 30 is extended through the respective axially aligned pair of the retaining holes 211 in the cage rings 20 so that the middle and end sections 32, 33 of each of the urging members 30 are received in the respective roller-receiving space 24 and that the folded ends 331 are retained in the respective retaining holes 211 in the cage rings 20. The primary rollers 40 are subsequently pressed into the roller-receiving spaces 24 to be urged by the urging members 30, respectively. Since the folded ends 331 of the urging members 30 are retained in the retaining holes 211 in the cage rings 20, undesired removal of the urging members 30 from the roller-receiving spaces 24 during pressing of the primary rollers 40 into the roller-receiving spaces 24 can be prevented from occurring, thereby eliminating the aforesaid drawback associated with the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed:

1. A roller bearing comprising:
an outer race,
a cage surrounded by said outer race and including two cage rings that are coaxially disposed and that are axially spaced apart from each other, and a plurality of pillars interconnecting said cage rings and displaced angularly from each other to define a plurality of roller-receiving spaces thereamong, each of said cage rings being formed with a plurality of retaining holes, each of which is in spatial communication with a respective one of said roller-receiving spaces, each of said retaining holes in one of said cage rings being axially aligned with a respective one of said retaining holes in the other of said cage rings;
a plurality of primary rollers received in said roller receiving spaces, respectively; and
a plurality of urging members, each of which is received in a respective one of said roller-receiving spaces for urging a respective one of said primary rollers, and each of which extends into a respective axially aligned pair of said retaining holes in said cage rings so as to be retained between said cage rings.

2. The roller bearing of claim 1, wherein each of said urging members is in the form of a bent plate that has two opposite end sections and a middle section extending between said end sections, said end sections being bent from said middle section toward each other to define two folded ends thereamong and to form two resilient arms for abutting resiliently against the respective one of said primary rollers, said folded ends formed on said bent plate of each of said urging members being received in the respective axially aligned pair of said retaining holes in said cage rings, respectively.

3. The roller bearing of claim 2, wherein each of said end sections of said bent plate of each of said urging members has a bent free end that is bent therefrom toward said middle section of said bent plate of the respective one of said urging members.

4. The roller bearing of claim 1, wherein each of said pillars has a spring-abutting side having a generally L-shaped surface that defines a shoulder and a recess, each of said urging members being received in said recess in a respective one of said pillars and being seated on said shoulder defined by said L-shaped surface of said spring-abutting side of the respective one of said pillars.

5. The roller bearing of claim 4, where n each of said pillars further has a roller-abutting side opposite to said spring-abutting side, and includes an inner segment and an outer segment reduced in width between said roller-abutting side and said spring-abutting side from said inner segment toward said outer race to define said L-shaped surface at said spring-abutting side and a bent surface at said roller-abutting side for guiding movement of a respective one of said primary rollers therealong.

6. The roller bearing of claim 1, wherein said outer race has an annular inner protrusion that protrudes inwardly therefrom and that is formed with a plurality of axially extending grooves which are angularly displaced so as to define a plurality of roller-driving surfaces thereamong for abutting against said primary rollers, respectively.

7. The roller bearing of claim 6, wherein said outer race further has two opposite end flanges that protrude inwardly and radially therefrom and that are respectively disposed at two opposite sides of said inner protrusion to define two retaining spaces thereamong, said roller bearing further comprising a plurality of auxiliary rollers and two auxiliary rings received in said retaining spaces, respectively, each of said auxiliary zings being formed with a plurality of roller-retaining holes, said auxiliary rollers being retained in said roller-retaining holes in said auxiliary rings, respectively, and being in rotational contact with said outer race.

8. The roller bearing of claim 7, further comprising an inner race extending into and through said outer race, said cage, and said auxiliary rings, and in contact with said primary rollers and said auxiliary rollers.
